(19) United States
(12) Patent Application Publication
(10) Pub. No.: US 2015/0074208 A1
(43) Pub. Date: Mar. 12, 2015

(54) EXPOSED GROUP OF RECIPIENTS FOR TEXT MESSAGE

(71) Applicant: Sanjib Kumar Rakshit, Bangalore (IN)

(72) Inventor: Sanjib Kumar Rakshit, Bangalore (IN)

(21) Appl. No.: 14/391,202

(22) PCT Filed: Jul. 6, 2012
(86) PCT No.: PCT/US2012/045775

§ 371 Date: Oct. 8, 2014

(51) Int. Cl. H04L 12/58

(52) U.S. Cl. CPC H04L 51/16; H04L 51/04
USPC 709/206

(57) ABSTRACT

Creating an exposed group of recipients for a text message includes creating the text message, wherein the text message is to be sent to multiple recipients. An exposed group of recipients is created from the recipients. The exposed group is included in the text message. A receiving device receiving the text message may identify the exposed group of recipients.

### BACKGROUND

Short messaging service (SMS) is a messaging service typically used by mobile devices, but can be used by any computer system with an SMS agent installed, to exchange text messages. The text messages may include text and/or multimedia, such as pictures, video, audio files, etc. SMS uses standardized communications protocols to exchange text messages. Text messaging may be the most widely used application in the world.

### BRIEF DESCRIPTION OF DRAWINGS

The embodiments are described in detail with reference to the examples shown in the following figures:

FIG. 1 illustrates a system;

FIG. 2 illustrates a device;

FIG. 3 illustrates a method for creating an exposed group for a text message;

FIG. 4 illustrates another method for creating an exposed group for a text message;

FIG. 5 illustrates a method for receiving a text message and displaying an exposed group;

FIGS. 6A-B show examples of graphical user interfaces generated on a sending device; and

FIGS. 7A-C show examples of graphical user interfaces generated on a receiving device.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

A user may send an SMS text message to multiple recipients simultaneously. However, a recipient cannot determine if the text message was only sent to him or her or whether the text message was sent to a group of recipients. In many instances, a recipient may forward the message to another recipient in the group because the recipient did not know the other recipient was part of the group of recipients that was sent the message.

According to an embodiment, a sender of a text message may create an exposed group of recipients when creating a text message. The exposed group of recipients is a group of multiple recipients that are being sent the text message from the sender. The text message may be addressed to a plurality of recipients and the exposed group may include all the recipients or may include some of the recipients but not all of the recipients. The sender may select which recipients are included in the exposed group. The exposed group is included in the text message and sent to the recipients. A recipient of the text message can view all the recipients in the exposed group. A text message is a message that may include text and/or multimedia, such as pictures, video, audio files, etc. The text message may be an SMS text message or a text message of another protocol whereby the protocol does not include a mechanism for identifying a plurality of recipients of the text message at the receiving device.

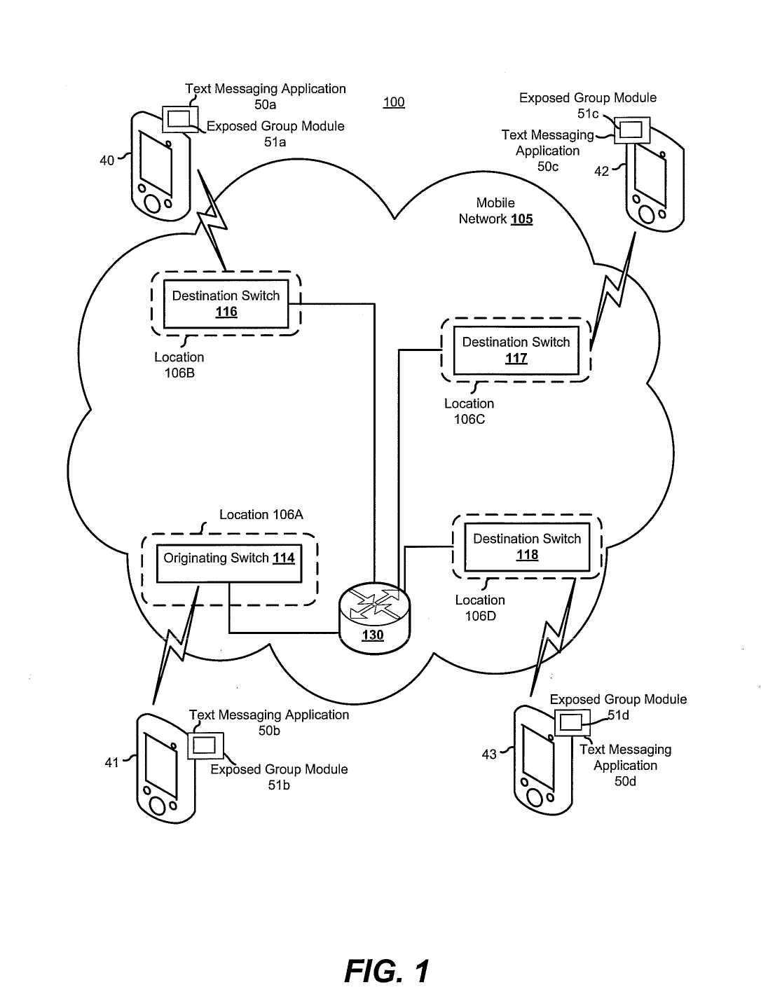

FIG. 1 illustrates a system 100 including a plurality of devices 40-43 connected via a network 105. The devices 40-43 include a text messaging application 50a-d that can create, send, and receive text messages and can include an exposed group of recipients in a text message for a sending device and can identify and display an exposed group of recipients at a receiving device. A sending device is a device sending a text message. A receiving device is a device receiving a text message. Any of the devices 40-43 may be a sending or a receiving device. The devices 40-43 are computer devices and may include a mobile device, such as a cellular phone, laptop, etc., or a stationary device, such as a desktop personal computer or any other type of computer device that can execute a text messaging application. FIG. 1 shows text messaging applications 50a-d in devices 40-43 respectively. Each text messaging application may create, send, receive and display text messages on the respective device. Also, the text messaging applications 50a-d may include exposed group modules 51a-d respectively. Each exposed group module may create and modify exposed groups, include exposed groups in text messages and display exposed groups. A recipient is an entity or user identified in the text message to receive the text message. A single text message may be sent to a plurality of recipients simultaneously.

The network 105 may include multiple switches, such as switch 114 and 116-118. The network 105 may be a mobile network supporting mobile devices and services for mobile devices, include a text messaging service. The network 105 may include a mobile switching center (MSC) 130 that can route text messages from a sending device to one or more receiving devices. In one example, the device 41 is a sending device. The text messaging application 50b creates a text message based on input from a user to be sent to a plurality of recipients of the devices 40, 42, and 43, which are the receiving devices in this example. The text messaging application 50b creates the text message and it is addressed to the recipients for the devices 40, 42, and 43. The exposed group module 51b in the text messaging application 50b creates an exposed group identifying two or more of the recipients and includes the exposed group in the text message. The text message is sent via the network 105 to the recipients associated with the devices 40, 42, and 43. For example, the switch 114 receives the text message from the sending device 41 and forwards it to the MSC 130. The MSC 130 routes the text message according to the recipients listed in the text message. The switches 116-118 for the locations for the devices 40, 42, and 43 receive the text message and send it to the corresponding receiving device. The text messaging applications 50a, 50c and 50d of the receiving devices 40, 42, and 43 display the text message and the exposed group modules 51a, 51c, and 51d can display the exposed group of recipients.

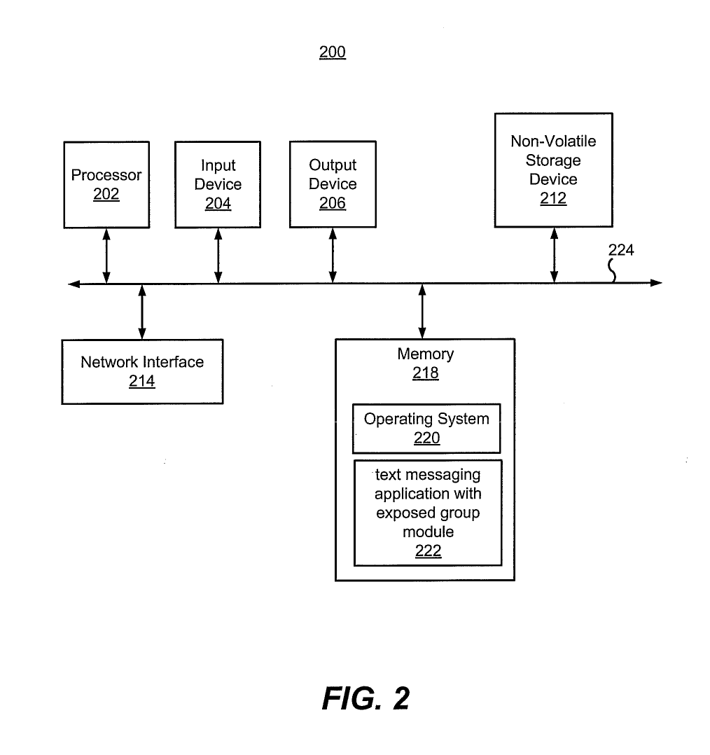

FIG. 2 shows a block diagram of a device that may be used for any of the devices 40-43. The device 200 is shown comprising hardware elements that may be electrically coupled via a bus 224. The hardware elements may include a processor 202, an input device 204 (e.g., keyboard, touchscreen, etc.), and an output device 202 (e.g., display, speaker, etc.). The device 200 may also include storage devices, such as memory 218 and a non-volatile storage device 212 (e.g., solid state storage, hard disk, etc.). The storage device 212 and memory 218 are examples of non-transitory computer readable storage media that may store machine readable instructions. For example, at runtime, the memory 218 may store an operating system 220 and a text messaging application 222 with an exposed group module. The text messaging application 222 can be one of the text messaging applications shown in FIG. 1. Other applications may be stored in the memory 218 as well. The non-volatile storage device 212 may also store data and the application 222. The computer system 200 may additionally include a network interface 214, which may be wireless and/or a wired network interface. The application 222, operating system 220 and other software may be comprised of machine readable instructions stored on the non-transitory computer readable storage media.

It should be appreciated that the computer system 200 may have numerous variations from that described above. For example, customized hardware might also be used and/or particular elements might be implemented in hardware, software (including portable software, such as applets), or both.

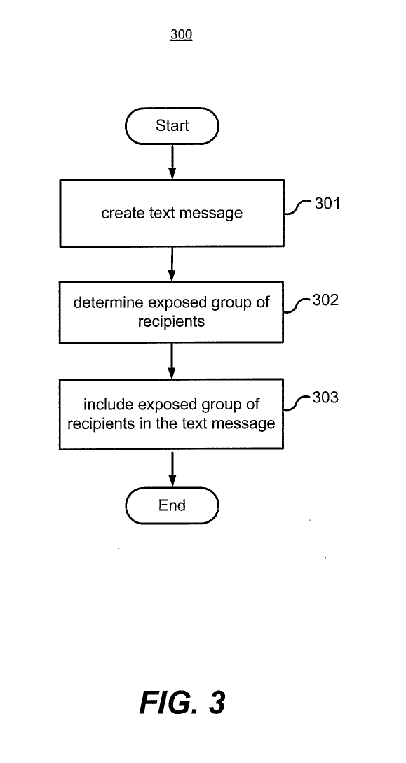

FIG. 3 shows an example of a method 300 of creating an exposed group of recipients for a text message. The methods 300 and 400 may be performed by a sending device, which may include any of the devices 40-43 shown in FIGS. 1 and 2. For example, the text messaging applications shown in FIGS. 1 and 2 may perform the methods.

At 301, a text message to be sent to a plurality of recipients is created. For example, a user executes the text messaging application on the device to compose a new text message. The text message is addressed to the plurality of recipients. The text message may include text and/or multimedia.

At 302, an exposed group of recipients from the plurality of recipients is determined. For example, the user selects one or more of the plurality of recipients to include in the exposed group.

At 303, the exposed group is included in the text message, and the text message is sent to the plurality of recipients, for example, in response to a user clicking a send button generated by the text messaging application. A receiving device receiving the text message may display the text message. Also, the text messaging application in the receiving device may identify the exposed group of recipients in the text message and display the recipients.

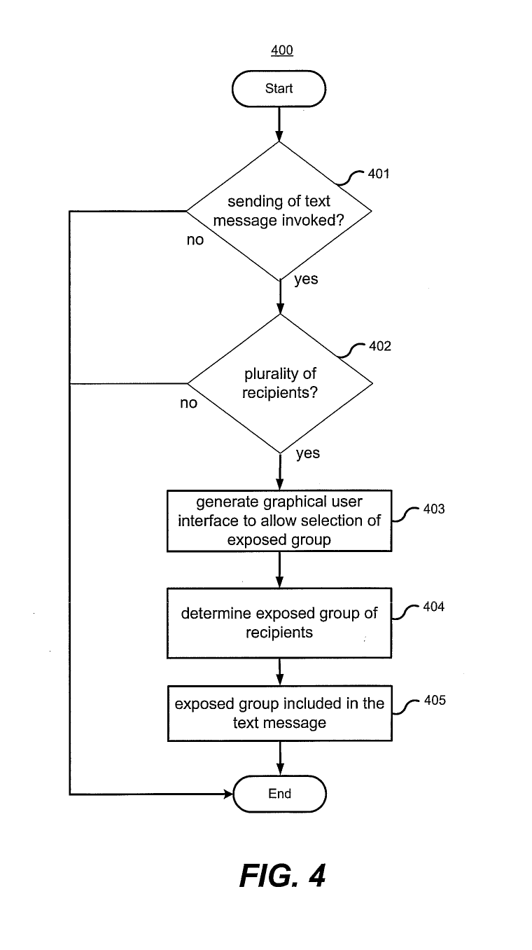

FIG. 4 illustrates an example of a method 400 for determining an exposed group of recipients. The method 400 may be performed by the text messaging application shown in FIGS. 1 and 2. The method 400 may be performed for 302 for the method 300.

At 401, a determination is made as to whether sending of a text message is invoked. For example, a user creates a text message and addresses the text message to one or more recipients. The user may click on a send button on a graphical user interface created by the text messaging application to invoke sending of the text message. The text messaging application determines whether the user clicked send to invoke sending of the text message.

At 402, if the sending of the text message is invoked, a determination is made as to whether the text message is addressed to a plurality of recipients. For example, a user may enter more than one recipient in a “TO” field in the text message prior to clicking the send button. If more than one recipient is identified in the “TO” field, then the text messaging application determines the text message is addressed to a plurality of recipients.

At 403, if the text message is addressed to a plurality of recipients, a graphical user interface may be generated that allows a user to select one or more of the plurality of recipients for an exposed group. For example, a list of the plurality of recipients is presented to the user via a display and the user may select one or more of the plurality of recipients for the exposed group. The user, for example, selects some or all of the plurality of recipients for the exposed group.

At 404, the recipients for the exposed group are determined from the user selection.

At 405, the recipients for the exposed group are included in the text message. In one example, the recipients are included in the body of the text message. The body may include text entered by the user. The recipients for the exposed group may be appended to the text entered by the user. The recipients for the exposed group may be preceded and followed by delimiters to distinguish the recipients from the text in the message. For example, the delimited recipients may be included in the body as //recipient1, recipient2// at the end of the text message. “recipient1” and “recipient2” are user IDs for the recipients in the exposed group and // are examples of delimiters that may be used. “recipient1” and “recipient2” may be cellular telephone numbers of the recipients. The exposed group of recipients are sent with the text message to the plurality of recipients. At the receiving devices of the plurality of recipients, the exposed group may be displayed.

In the example described above, the text messaging application may determine if the sending of text message is invoked and then automatically generates a graphical user interface that allows a user to select recipients for the exposed group assuming the text message is addressed to a plurality of recipients. In another example, the text messaging application may generate a “Create Exposed Group” button on a graphical user interface \ddot{r} the text messaging application determines that the text message is addressed to a plurality of recipients. The user may click on the “Create Exposed Group” button to select recipients for the exposed group if the user desires to create an exposed group. Then, the user may select the recipients for the exposed group prior to clicking a “Send” button to invoke sending of the text message.

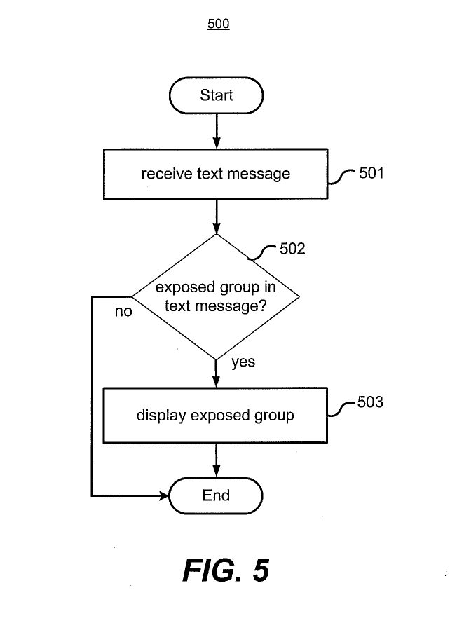

FIG. 5 illustrates an example of method 500 for identifying an exposed group of recipients for a text message. The method 500 may be performed by a text messaging application at a receiving device, such as any of the text messaging applications shown in FIG. 1 or 2.

At 501, a text message is received at a receiving device. For example, any of the devices 40-43 shown in FIG. 1 may be receiving devices.

At 502, a determination is made as to whether an exposed group of recipients is included in the text message. For example, the text messaging application in the receiving device parses the body of be text message for predetermined delimiters. If the delimiters are identified, then the text messaging application determines the text message includes the exposed group.

At 503, if the text message is determined to include the exposed group, the exposed group is displayed to the user. For example, the text messaging application may identify the recipients co-located with the delimiters. The text messaging application may display the recipients. For example, if the recipients are identified by a telephone number, the text messaging application may display the telephone numbers or may perform a lookup on a contact list stored in the receiving device to determine if the telephone number is associated with another user ID, such as a name. If another user ID is identified by the lookup, that user ID may be displayed.

In another example, the user may scroll through the body of the text message to determine if the exposed group is in the text message. If the exposed group is in the text message, the user can view the exposed group in the body. In yet another example, the text messaging application may mask the exposed group in the body of the text message so the user cannot view the exposed group when viewing the body of the text message. In this example, the user may be presented with an option to view the exposed group.

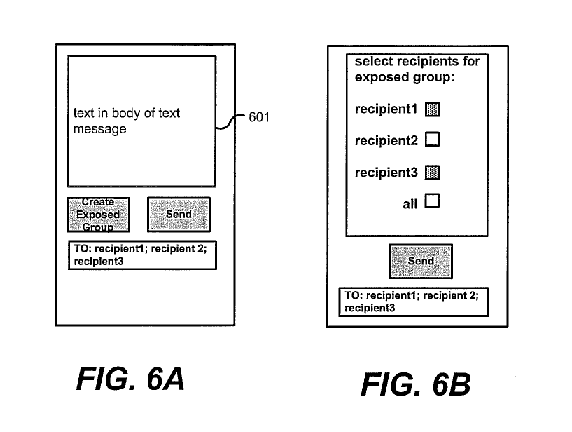

FIGS. 6A-B show examples of graphical user interfaces that may be created by the text messaging application on a sending device, which may include any of the devices 4043 shown in FIGS. 1 and 2.

FIG. 6A shows the body of the text message 601 including text entered by the user. In this example, the text message is addressed to recipients 1-3. The text messaging application determines the text message is addressed to a plurality of recipients and includes a “Create Exposed Group” button on the graphical user interface.

FIG. 6B shows a graphical user interface that allows the user to select recipients for the exposed group. In this example, recipient1 and recipient3 are selected. This graphical user interface may be generated in response to the user selecting the “Create Exposed Group” button shown in FIG. 6A or may be generate automatically, without the user having to select a “Create Exposed Group” button, in response to determining the text message is addressed to a plurality of recipients and in response to the user invoking the sending of the text message.

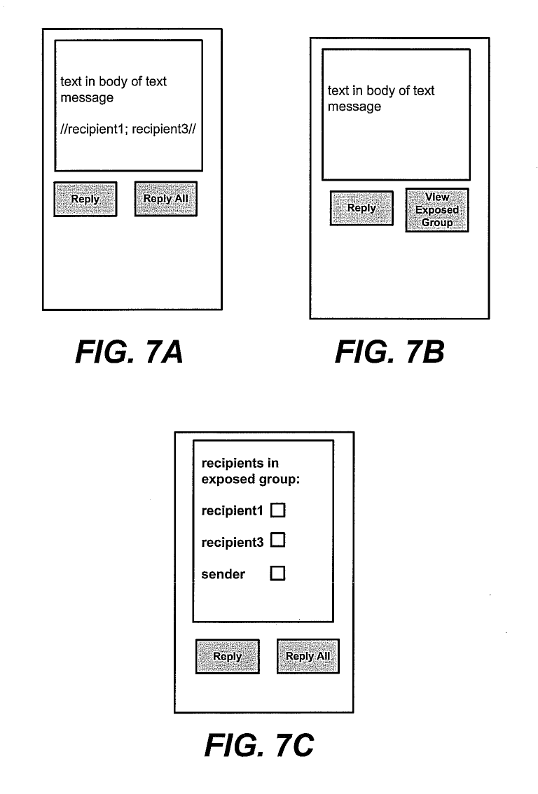

FIGS. 7A-C show examples of graphical user interfaces that may be created by the text messaging application on a receiving device, which may include any of the devices 40-43 shown in FIGS. 1 and 2.

The exposed group of recipients may be included in the body of the text message. FIG. 7A shows an example whereby the exposed group of recipients is included in the body and is viewable by the user in the display. FIG. 7B shows an example, whereby the exposed group of recipients is masked so it cannot be viewed with the rest of the text in the body. In this example, a “View Exposed Group” button may be selected to view the recipients in the exposed group. FIG. 7C shows the recipients in the exposed group, which may be displayed in response to selection of the “View Exposed Group” button.

In FIG. 7A, the user select a “Reply” button to reply just to the sender or a “Reply All” button to reply to the sender and all the recipients in the exposed group or may be presented with an option to select the sender and/or one or more of the recipients in the exposed group. FIG. 7C shows an example whereby a user may select the sender and/or one or more of the recipients for replying to a received text message.

While the embodiments have been described with reference to examples, various modifications to the described embodiments may be made without departing from the scope of the claimed embodiments.

What is claimed is:

1. A method of creating an exposed group of recipients for a text message, the method comprising:
creating the text message to be sent to a plurality of recipients;
determining the exposed group of recipients from the plurality of recipients; and
including the exposed group in the text message, wherein a receiving device receiving the text message is to identify the exposed group of recipients.

2. The method of claim 1, wherein determining the exposed group of recipients comprises:
receiving an indication of the recipients in the exposed group from a user of a sending device creating the text message; and
including the indicated recipients in the exposed group.

3. The method of claim 2, wherein receiving the indication comprises:
determining whether the text message has multiple recipients;
determining whether the user has invoked sending of the text message;
in response to determining the text message has multiple recipients and the user has invoked sending the text message, generating a graphical user interface prompting the user to select the recipients for the exposed group; and
determining the recipients in the exposed group from the user selection.

4. The method of claim 1, wherein including the exposed group in the text message comprises:
including the exposed group in a body of the text message, wherein the exposed group includes an identifier for each recipient in the exposed group.

5. The method of claim 4, wherein including the exposed group in the body of the text message comprises:
delimiting the exposed group in the body of the text message with delimiters, wherein the receiving device is to identify the exposed group in the body from the delimiters.

6. The method of claim 1, wherein the exposed group of recipients includes some of the plurality of recipients but not all of the plurality of recipients.

7. The method of claim 1, wherein the text message is a short messaging service text message.

8. A method comprising:
receiving a text message sent to a plurality of recipients;
determining whether an exposed group of recipients from the plurality of recipients is included in the text message; and
in response to determining the exposed group is in the text message, displaying the exposed group of recipients to a user of a receiving device receiving the text message, wherein the displayed exposed group includes an identifier for each of the recipients in the exposed group.

9. The method of claim 8, wherein the identifier for each recipient comprises an identifier sent in the text message or a different identifier stored in the receiving device that is selected for the displaying based on the identifier sent in the text message.

10. The method of claim 8, wherein determining whether the exposed group of recipients from the plurality of recipients is included in the text message comprises:
parsing a body of the text message to identify the exposed group.

11. The method of claim 10, wherein parsing the body of the text message to identify the exposed group comprises:
parsing the body for delineated text that includes the exposed group.

12. The method of claim 8, wherein the exposed group of recipients includes some of the plurality of recipients but not all of the plurality of recipients.

13. The method of claim 8, wherein the text message is a short messaging service text message.

14. A device to send a text message comprising:
a storage device to store a text messaging application;
a processor to execute the text messaging application; and
a network interface to send the text message, wherein the text messaging application, when executed by the processor, is to:
create the text message to be sent to a plurality of recipients;
generate a graphical user interface to select recipients for an exposed group from the plurality of recipients;
determine the exposed group from the selected recipients; and
include the exposed group in the text message, wherein the recipients in the exposed group includes some but not all of the plurality of recipients.

15. The device of claim 14, wherein the exposed group of recipients is included in a body of the text message.
